(19) United States
(12) Patent Application Publication
(10) Pub. No.: US 2026/0061432 A1
(43) Pub. Date: Mar. 5, 2026

(54) METHOD FOR SEPARATING A MIXTURE OF GRANULES VIA THE TRIBOELECTRIC EFFECT

(71) Applicant: SKYTECH, LE VAL D'HAZEY (FR)

(72) Inventor: Pierre SOMMEN, PACY-SUR-EURE (FR)

(21) Appl. No.: 19/105,277

(22) PCT Filed: Aug. 25, 2023
(86) PCT No.: PCT/EP2023/073334

§ 371 Date: Feb. 20, 2025

(30) Foreign Application Priority Data
Aug. 26, 2022 (FR) FR2208566

(51) Int. Cl. B03C 7/08; B01F 27/05; B03C 7/00; B05C 19/02

(52) U.S. Cl. CPC B03C 7/08; B01F 27/05; B03C 7/003; B03C 7/006; B05C 19/025

(57) ABSTRACT

The invention relates to a method for separating, in batches, a mixture comprising granules of at least two materials, comprising the following successive steps for each of the batches:
introducing a batch into a fluidizing chamber (40) defined by a reactor (16) and obtaining an introduced batch (38),
the granules of the batch being initially at rest, starting fluidization and obtaining at least one fluidized bed (18) in the fluidizing chamber, the fluidization being achieved by way of at least one ascending stream of fluid (42) that puts at least a fraction of the granules of the introduced batch into suspension, the fluidized bed being charged via the triboelectric effect,
modifying the stream of fluid (42) and discharging at least 90% by mass of the introduced batch from the fluidizing chamber,
passing the fed out batch in one or more electric fields intended to separate the discharged batch.

The present invention relates to a method of separation of a mixture comprising granules of at least a first material and of a second material, the mixture being charged via the triboelectric effect and passing through one or a plurality of electric fields for separating the mixture between at least a first mixture rich in granules of the first material and a second mixture rich in granules of the second material.

The invention further relates to a corresponding installation.

The triboelectric effect is an electrostatic phenomenon whereby at least two materials of different nature electrify each other by contact. Electrons from one are transferred to the other and such situation persists. Thereof is called static electricity. The lack of electrons of one creates a positive electric charge, whereas the excess of electrons of the other creates a negative charge. It is known to then separate granules from such materials using the passage through an electric field, which applies opposite forces to the granules according to the respective electric charges thereof.

To increase the triboelectric effect, mechanical energy is usually provided by rubbing the materials against each other for a certain period of time. The electrical charge gradually increases, at a rate that depends on the materials and surrounding conditions, in particular the level of humidity. In some cases, the charge may decrease if the friction lasts too long.

In order to obtain a separation method having an advantageous productivity, it is known to continuously feed in the mixture to be separated into a stirring box. The particles are fed at one end of the box and exit at another end. However, the progression of the granular medium in the box, due to the movements of the box, to shape and to orientation thereof, is difficult to control. It may happen that the granules at the outlet are insufficiently charged, or that the outlet flow-rate is low.

Furthermore, if the nature of the mixture to be separated changes, complex mechanical modifications have to be made in order to again obtain an adjustment suitable for the new nature of the mixture.

In order to increase the speed of charging and the flow-rate of the mixture at the Outlet, it has been proposed to continuously produce a fluidized bed in a reactor, from the mixture to be separated. The fluidized bed is obtained by an ascending stream of fluid, usually air. However, once again, the extraction of granules and more generally the progression of the fluidized bed in the reactor proves difficult to manage. In addition, when the materials have a fairly long charging time, the fluidization reactor has to be large, which entails significant costs for the blower producing the stream of fluid, and for the possible heating of the stream of fluid.

In document WO 2010/109096, the fluidized bed is static to a variable extent in the reactor, and the granules, once charged, are attracted out of the fluidized bed according to the charge thereof by conveyor belts forming electrodes around the fluidized bed. The extraction is carried out continuously, and the fluidized bed is fed continuously by the arrival of new granules. Nevertheless, such a reactor is again very difficult to adjust, in particular in relation to the level of electric charge. It may also happen that insufficiently charged granules accumulate in the reactor and block same.

A goal of the invention is thus to provide a separation method which solves all or some of the problems mentioned hereinabove, which is both effective from the point of view of separation and productive, while being simple to manage, in particular when the nature of the mixture to be separated changes.

To this end, the subject matter of the invention is a method of separation, by batches, of a mixture comprising granules of at least a first material and of a second material, comprising the following successive steps for each batch:
feeding in one of the batches into a fluidization chamber defined by a reactor and obtaining a fed in batch,
the granules of the fed in batch being initially at rest in the fluidization chamber, starting a fluidization and obtaining at least one fluidized bed in the fluidization chamber, the fluidization being obtained by at least one ascending stream of fluid passing through the fed in batch and putting at least a fraction of the granules of the fed in batch in suspension, the fluidized bed being charged via the triboelectric effect,
modification of the stream of fluid and discharging at least 90% by mass of the fed in batch from the fluidizing chamber and obtaining a fed out batch, and
passage of the fed out batch through one or a plurality of electric fields suitable for separating the fed out batch into at least a first mixture rich in granules of the first material and a second mixture rich in granules of the second material.

According to particular embodiments, the method has one or a plurality of the following features, taken individually or according to all technically possible combinations:
the modification of the stream of fluid comprises a reduction in the flow-rate of the stream of fluid making the granules of the fluidized bed fall onto a receiving surface of the reactor;
after the reduction of the flow-rate of the stream of fluid, the stream of fluid has a non-zero residual flow-rate in the fluidization chamber after the feeding out of the fed in batch;
the reactor is rotatably mounted relative to a frame between at least a first position occupied during the fluidization and a second position occupied during the feeding out and in which the receiving surface is more inclined relative to the frame than in the first position, the feeding out comprising a displacement of at least 90% by mass of the fed in batch, by gravity, along the receiving surface toward the outside of the fluidization chamber;
the modification of the stream of fluid comprises an increase in the flow-rate of the stream of fluid, the feeding out comprising an ejection of at least 90% by mass of the fluidized bed out of the fluidization chamber caused by the increase in the flow-rate;
the reactor comprises a shell defining: an inlet for feeding in, the inlet being open for the feeding in, then closed after the feeding in, and an outlet for the feeding out of at least 90% by mass of the fed in batch, the outlet being open for the feeding out, then closed after the feeding out;
the reactor defines at least one circuit forming a loop for the stream of fluid, the reactor including at least one blower for obtaining the stream of fluid in the circuit;
the stream of fluid is at a temperature comprised between 45° C. and 75° C.; and
the fluidization being obtained under given conditions, the granules of the fed in batch are maintained in the form of said fluidized bed for a predetermined period, the granules of the first material taking an electrical charge greater than 90% of a maximum electrical charge that can be obtained under the given conditions.

The invention further relates to an installation for the separation, by batches, of a mixture comprising granules of at least a first material and of a second material, the installation comprising:
a reactor defining a fluidization chamber intended to receive one of the batches in order to obtain a fed in batch, the reactor being suitable for creating a fluidized bed in the fluidization chamber, the granules of the fed in batch being initially at rest in the fluidization chamber, the reactor being suitable for producing at least one ascending stream of fluid passing through the fed in batch and putting at least a fraction of the granules of the fed in batch in suspension so as to obtain the fluidized bed, the fluidized bed being charged via the triboelectric effect, the reactor being suitable for modifying the stream of fluid and for feeding out at least 90% by mass from the fed in batch outside the fluidization chamber so as to obtain a fed out batch, and
a separation unit suitable for creating at least one or a plurality of electric field(s), the installation being suitable for passing the fed out batch into the electric field(s) and for separating the fed out batch between at least a first mixture rich in granules of the first material and a second mixture rich in granules of the second material.

The invention will be better understood upon reading the following description, given only as an example and making reference to the enclosed drawings, wherein:

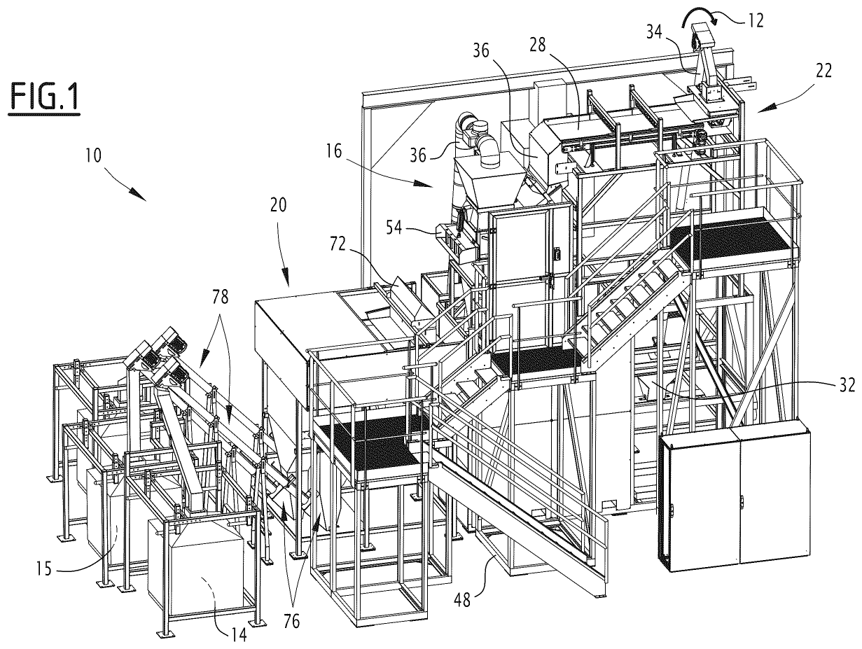

FIG. 1 is a general perspective view of a separation installation according to the invention, serving to carry out a method according to the invention,

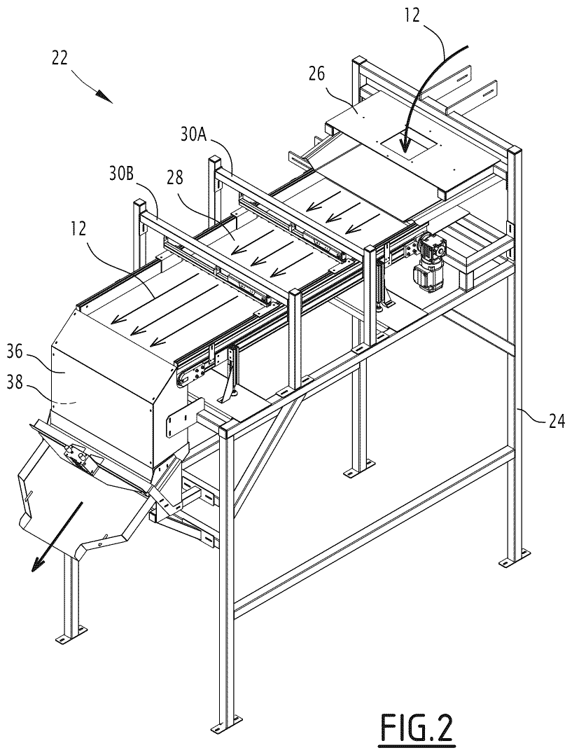

FIG. 2 is a perspective view of a system for conveying the mixture of the installation represented in FIG. 1,

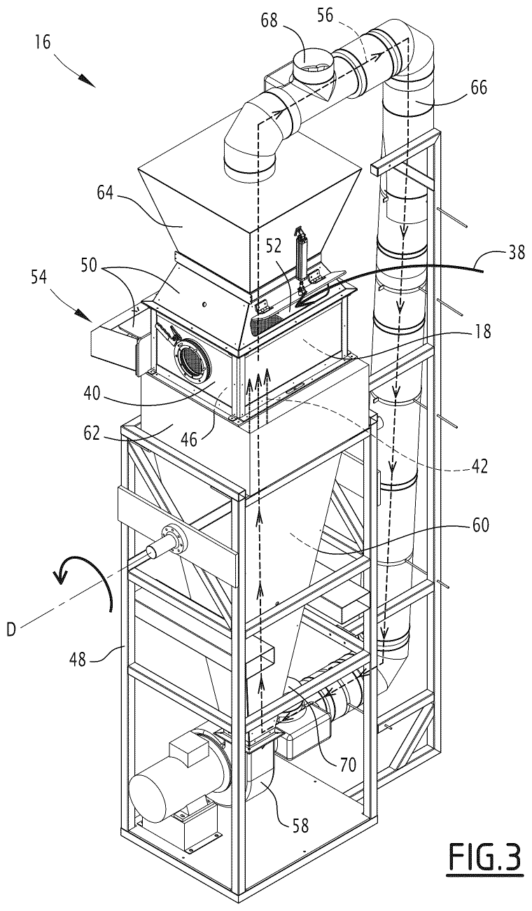

FIG. 3 is a perspective view of a fluidization reactor of the installation represented in FIG. 1, the reactor being in a first position occupied during the fluidization of a batch,

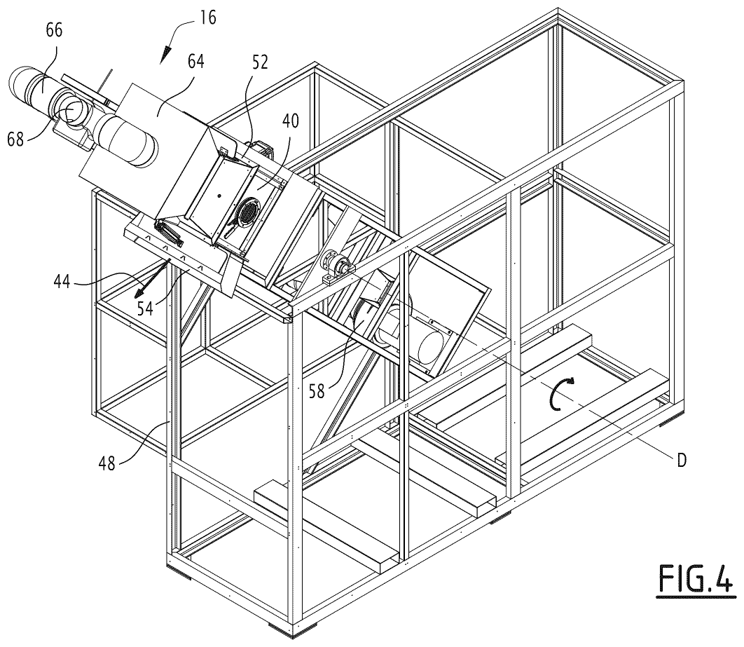

FIG. 4 is a perspective view of the reactor shown in FIG. 3, the reactor being in a second position occupied during the feeding out of a batch from the reactor, and

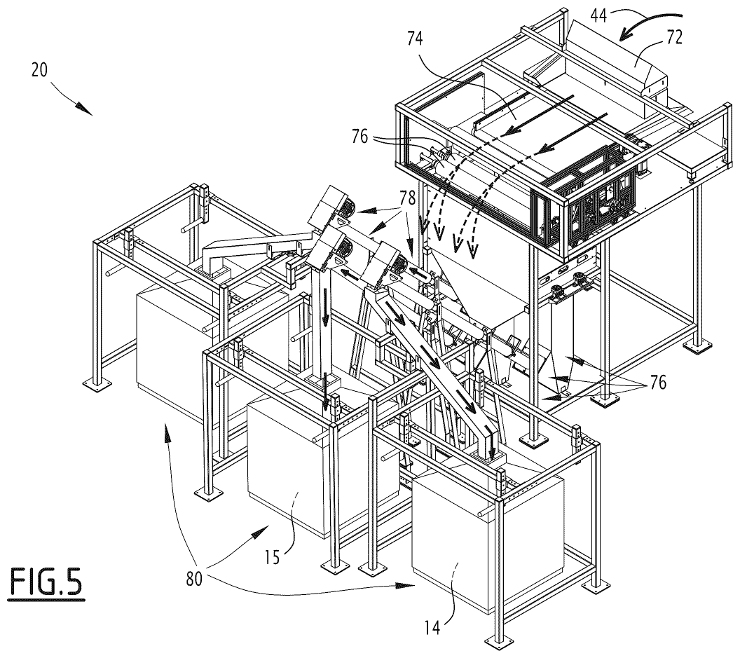

FIG. 5 is a perspective view of a separation unit of the installation represented in FIG. 1.

With reference to FIG. 1, an installation 10 according to the invention is described for separating a mixture 12 comprising granules (not shown) of at least a first material and of a second material, into at least a first mixture 14 rich in granules of the first material and a second mixture 15 rich in granules of the second material.

The mixture 12 comprises e.g. as a first material and a second material:
acrylonitrile butadiene styrene (ABS) and polystyrene (PS),
polypropylene (PP) and polyethylene (PE), or
polypropylene (PP) and polystyrene (PS).

The granules of the first material and of the second material are apt to be electrically charged when same are rubbed against each other via the triboelectric effect.

The first mixture 14 is e.g. rich in granules of the first material, in the sense that same comprises, by mass, a proportion of granules of the first material which is higher than in the second mixture 15. Similarly, the second mixture 15 is e.g. rich in granules of the second material, in the sense that same comprises, by mass, a higher proportion of granules of the second material than in the first mixture 14.

Advantageously, the first mixture 14 comprises, by mass, a proportion of granules of the first material greater than 95%.

Advantageously, the second mixture 15 comprises, by mass, a proportion of granules of the second material greater than 95%.

According to a variant (not shown), the mixture 12 to be separated comprises granules of three distinct materials, or more than three materials.

In a variant, the mixture 12 is e.g. quaternary (includes four materials) and is separated into a first binary mixture 14 (rich in two of the materials) and a second binary mixture 15 (rich in the other two materials).

Advantageously, the first mixture 14 then comprises, by mass, a granule content of two of the materials greater than 95%, and the second mixture 15 then comprises, by mass, a granule content of the other two materials greater than 95%.

For example, the mixture 12 to be separated comprises the materials PS, ABS, PP and PE and is separated into a first mixture rich in PP/PE, a second mixture rich in ABS/PS, and a third undifferentiated mixture, with a composition similar to the mixture 12.

The installation 10 is suitable for operating by batches at least in a reactor 16 (FIG. 3) suitable for producing a fluidized bed 18 (FIG. 3) from the mixture 12. However, the batches of mixture to be separated advantageously follow one another at a high rate, which does not impair the productivity of the installation 10, quite the opposite, the installation being advantageously suitable for perfectly controlling the reactor 16, in particular the residence time of the granules in the reactor.

The installation 10 further comprises a separation unit 20 (FIG. 5). In the example, the installation 10 comprises a special conveying system 22 (FIG. 2), to form the batches fed in one by one into the reactor 16.

According to variants (not shown), the batches are already formed and directly fed in into the reactor 16, or are produced in a manner known per se other than the manner permitted by the conveying system 22.

In the example, the conveying system 22 (FIG. 2) comprises a frame 24, a vibrating table 26 suitable for creating a layer of granules from the mixture 12, a conveyor 28 for moving the layer of granules relative to the frame 24, and two ionizing bars 30A, 30B placed above the conveyor.

In a variant, the conveying system 22 comprises only one ionizing bar, or more than two.

In the example, the conveying system 22 comprises a hopper 32 containing the mixture to be treated, and a worm screw 34 for conveying the mixture 12 from the hopper to the vibrating table 26. The conveying system 22 comprises e.g. a buffer hopper 36 situated at the end of the conveyor 28.

The ionizing bars 30A, 30B are suitable for electrically discharging the mixture 12 to be separated. The ionizing bars 30A, 30B can be e.g. activated and advantageously adjusted in frequency and distance with respect to the conveyor. The frequency is advantageously adjusted directly on the ionizing bars 30A, 30B.

The buffer hopper 36 is suitable for forming a batch 38 of mixture, the mass of which is e.g. comprised between 30 and 100 kg, and is advantageously about 50 kg.

The reactor 16 (FIGS. 3 and 4) defines a fluidization chamber 40 suitable for receiving a batch 38 fed in, in the example coming from the buffer hopper 36.

The reactor 16 is suitable for creating the fluidized bed 18 in the fluidization chamber 40. The reactor 16 is suitable for producing at least one ascending stream of fluid 42 passing through the fed in batch 38, in order to put at least a fraction of the granules of the fed in batch, in suspension and for obtaining the fluidized bed 18.

The reactor 16 is suitable for modifying the stream of fluid 42 and for feeding at least 90% by mass of the fed in batch 38 out of the fluidization chamber 40 so as to obtain a fed out batch 44 (FIG. 4). Preferably, all or almost all (more than 99% by mass) of the batch 38 fed in is fed out.

The reactor 16 is e.g. configured so that the stream of fluid 42 is at a temperature comprised between 45° C. and 75° C. It is thereby possible to dry the fluid and to enhance the triboelectricity.

The reactor 16 defines e.g. a receiving surface 46, e.g. a grate, situated under the fluidized bed 18 and intended to receive the granules if the flow-rate of the stream of fluid 42 is reduced, the fluidized bed falling back onto the receiving surface.

The reactor 16 is e.g. mounted to rotate with respect to a frame 48 of the installation 10 between at least a first position (FIG. 3) occupied during the fluidization, and a second position (FIG. 4) occupied during the feeding out and in which the receiving surface 46 is more inclined with respect to the frame 48 than in the first position.

The reactor 16 is e.g. movable in rotation about an axis D which is advantageously horizontal.

The reactor 16 comprises e.g. a shell 50 defining an inlet 52 for the feeding in of the mixture 12, the inlet being open for the feeding in, then closed after the feeding in. The shell 50 defines an outlet 54 for the feeding out of at least 90% by mass of the batch 38 fed in, the outlet being open for the feeding out and then closed after the feeding out

In the example, the reactor 16 defines at least one circuit 56 forming a loop for the stream of fluid 42, the reactor including at least one blower 58 for obtaining the stream of fluid 42 in the circuit 56. The reactor 16 advantageously comprises a homogenization chamber 60 for homogenizing the stream of fluid 42, and a heating system 62 suitable for heating the stream of fluid 42. The reactor 16 advantageously comprises a recuperator 64 and a sheath 66 connecting the recuperator to the fan 58.

In the example, the circuit 56 includes the fan 58, the homogenization chamber 60, the heating system 62, the fluidization chamber 48, the recuperator 64 and the sheath 66.

The fluidization chamber 40 is e.g. delimited at the bottom (in the first position) by the receiving surface 46, which is advantageously permeable to the stream of fluid 42, laterally by the shell 50, advantageously having at least one transparent wall enabling the fluidized bed 18 to be seen, and above by the recuperator 64.

The homogenization chamber 60 extends e.g. between the blower 58 and the heating system 62. The homogenization chamber 60 has e.g. an upwardly flared shape (in the first position). The homogenization chamber 60 is advantageously delimited laterally by four flat faces.

The fluid is e.g. air, or previously dried air.

The recuperator 64 is advantageously suitable for filtering the stream of fluid 42 and for removing fine particles (not shown) therefrom, so that the latter do not return to the blower 58.

The reactor 16 is advantageously suitable for operating in a closed circuit, or in fresh air. The sheath 66 has e.g. an outlet 68 for the stream of fluid 42 in the “fresh air” mode. The blower 58 further includes an air intake 70 for the same reasons.

In the first position, the receiving surface 46 is e.g. substantially horizontal. In the second position, the receiving surface 46 is e.g. inclined at about 45° (at plus or minus 5°, or even 10°).

The separation unit 20 (FIG. 5) comprises e.g. a hopper 72, a conveyor 74, and electrodes 76 suitable for generating the electric field(s). The separation unit 20 comprises e.g. three separation compartments 76 and three worm screws 78 enabling three bags 80 to be filled at once.

The operation of the installation 10 will now be described. Same illustrates a method according to the invention.

The conveying system 22 forms batches of the mixture 12. The worm screw 34 draws the mixture 12 from the hopper 32 and conveys same to the vibrating table 26. The vibrating table 26 advantageously creates a layer of mixture on the conveyor 28, which conveys the layer to the buffer hopper 36 wherein a batch 38 is formed.

By passing under the ionizing bars 30A, 30B, the mixture 12 is electrically discharged. It is a question of advantageously carrying out an electrical neutralization.

The reactor 16 is in the first position and the inlet 52 is open. The buffer hopper 36 feeds in the batch 38 into the fluidization chamber 40.

The flow-rate of the stream of fluid 42 is then e.g. zero in the fluidization chamber 40. The granules of the fed in batch are initially at rest in the fluidization chamber 40.

According to an advantageous variant, the flow-rate of the stream of fluid 42 is not zero during the feeding in, but has a value such that the granules of the fed in batch 38 are at rest (no fluidized bed). It is thereby possible e.g. to more easily maintain a desired temperature in the fluidization chamber 40.

The inlet 52 is then closed and the flow-rate of the stream of fluid 42 is increased to a value which makes it possible to put at least a fraction of the granules, preferably all the granules, of the batch 38 fed in, into suspension, in order to obtain the fluidized bed 18. The fluidized bed 18 is then charged via the triboelectric effect.

The fluidization is obtained under given conditions (temperature of the stream of fluid, humidity, flow-rate of the stream of fluid, etc.), the granules of the batch 38 fed in are advantageously maintained in the form of the fluidized bed 18 for a predetermined period, the granules of the first material taking an electrical charge greater than 90% of a maximum electrical charge which would be obtained under the same given conditions by maintaining the granules of the batch 38 fed in, in the form of the fluidized bed 18 for a period longer than the predetermined period. In other words, one waits sufficiently long to obtain an electric charge greater than 90% of the maximum charge possible under the given conditions.

The maximum possible charge under the given conditions can be determined by a person skilled in the art by simple measurements in the fluidization chamber 40 or in the laboratory.

The flow-rate of the stream of fluid 42 is then reset to the reduced value thereof, or reset to zero, and at least 90% by mass of the batch 38 fed in, preferably the whole fed in batch, is fed out from the fluidization chamber 40. For example, the granules of the fluidized bed 18 fall back onto the receiving surface 46.

The outlet 54 is open and the reactor 16 is tilted from the first position to the second position. The receiving surface 46 tilts. The granules move, by gravity, along the receiving surface 46 and leave the fluidization chamber 40 via the outlet 54.

The fed out batch 44 arrives in the separation unit 20.

The outlet 54 of the reactor 16 is closed and the reactor is returned to the first position, in which it can receive a new batch of mixture 12.

In the separation unit 20, the fed out batch 44 is separated at least between the first mixture 14 and the second mixture 15. In the example shown, the fed out batch 44 is separated into three mixtures, the third being of undifferentiated composition, e.g. similar to the composition of the mixture 12 to be separated. The third mixture is generally recycled into the mixture 12 to be separated.

According to a variant of the method, the granules are not fed out by reducing the flow-rate of the stream of fluid 42 and by inclining the reactor 16 with respect to the frame 48, but by increasing the flow-rate of the stream of fluid 42. The feeding out then comprises an ejection of at least 90% by mass of the fluidized bed 18 out of the fluidization chamber 40 via an outlet (not shown) provided in the circuit 56 for the stream of fluid 42. Instead of the particles of the fluidized bed 18 falling back onto the receiving surface 46, same are pushed upwards by increasing the flow-rate of the stream of fluid 42.

Due to the features described hereinabove, the separation method is effective from the point of view of the separation, since the granules are correctly electrically charged. Although the method is carried out in batches in the reactor, the method remains productive. Indeed, the duration of fluidization is perfectly controlled and the risks of malfunction, such as clogging, are reduced. The method is simple to manage, even when the nature of the mixture to be separated changes, due to a parameterization of the key factors (fluidization time, temperature, air flow-rate) which is facilitated.

1. A method for separating, by batches, a mixture comprising granules of at least a first material and of a second material, comprising the following successive steps for each batch:
feeding in one of the batches into a fluidization chamber defined by a reactor and obtaining a fed in batch,
the granules of the fed in batch being initially at rest in the fluidization chamber, starting a fluidization and obtaining at least one fluidized bed in the fluidization chamber the fluidization being obtained by at least one ascending stream of fluid passing through the fed in batch and putting at least a fraction of the granules of the fed in batch in suspension, the fluidized bed being charged via the triboelectric effect,
modification of the stream of fluid and feeding out at least 90% by mass of the fed in batch from the fluidizing chamber and obtaining a fed out batch, and
passage of the fed out batch through one or a plurality of electric fields suitable for separating the fed out batch into at least a first mixture rich in granules of the first material and a second mixture rich in granules of the second material.

2. The method according to claim 1, wherein the modification of the stream of fluid comprises reducing the flow-rate of the stream of fluid making the granules from the fluidized bed fall onto a receiving surface of the reactor.

3. The method according to claim 2, wherein after the reduction of the flow-rate of the stream of fluid, the stream of fluid has a non-zero residual flow-rate in the fluidization chamber after the feeding out of the fed in batch.

4. The method according to claim 2, wherein the reactor is rotatably mounted relative to a frame between at least a first position occupied during the fluidization and a second position occupied during the feeding out and in which the receiving surface is more inclined relative to the frame than in the first position, the feeding out comprising a displacement of at least 90% by mass of the fed in batch, by gravity, along the receiving surface toward the outside of the fluidization.

5. The method according to claim 1, wherein the modification of the stream of fluid comprises an increase in the flow-rate of the stream of fluid, the feeding out comprising an ejection of at least 90% by mass of the fluidized bed out of the fluidization chamber caused by the increase in the flow-rate.

6. The method according to claim 1, wherein the reactor comprises a shell defining:
an inlet for the feeding in, the inlet being opened for the feeding in and then closed after the feeding in, and
an outlet for the feeding out of at least 90% by mass of the fed in batch, the outlet being opened for the feeding out and then closed after the feeding out.

7. The method according to claim 1, wherein the reactor defines at least one circuit forming a loop for the stream of fluid, the reactor including at least one blower for obtaining the stream of fluid in the circuit

8. The method according to claim 1, wherein the stream fluid is at a temperature comprised between 45° C. and 75° C.

9. The method according to claim 1, wherein, the fluidization being obtained under given conditions, the granules of the fed in batch are maintained in the form of said fluidized bed for a predetermined period, the granules of the first material taking an electrical charge greater than 90% of a maximum electrical charge that can be obtained under the given conditions.

10. An installation for the separation, by batches, of a mixture comprising granules of at least a first material and of a second material, the installation comprising:
a reactor defining a fluidization chamber intended to receive one of the batches in order to obtain a fed in batch, the reactor being suitable for creating a fluidized bed in the fluidization chamber, the granules of the fed in batch being initially at rest in the fluidization chamber the reactor being suitable for producing at least one ascending stream of fluid passing through the fed in batch and putting at least a fraction of the granules of the fed in batch in suspension so as to obtain the fluidized bed, the fluidized bed being charged via the triboelectric effect, the reactor being suitable for modifying the stream of fluid and for feeding out at least 90% by mass from the fed in batch outside the fluidization chamber so as to obtain a fed out batch, and
a separation unit suitable for creating at least one or a plurality of electric field(s), the installation being suitable for passing the fed out batch into the electric field(s) and for separating the fed out batch between at least a first mixture rich in granules of the first material and a second mixture rich in granules of the second material.
